(19) United States
(12) Patent Application Publication
(10) Pub. No.: US 2026/0266313 A1
(43) Pub. Date: Sep. 10, 2026

(54) FAN

(71) Applicant: Shenzhen Giikfun Technology Co., Ltd., Shenzhen (CN)

(72) Inventor: Ning XU, Shenzhen City (CN)

(73) Assignee: Shenzhen Giikfun Technology Co., Ltd., Shenzhen (CN)

(21) Appl. No.: 19/657,158

(22) Filed: Apr. 24, 2026

(51) Int. Cl. F04D 29/64; H01F 7/02

(52) U.S. Cl. CPC F04D 29/646; H01F 7/02

(57) ABSTRACT

A fan, including: a fan assembly, a magnetic component and a flexible constraint component. The fan assembly is configured to convert electrical energy into mechanical energy for generating airflow. The magnetic component is connected to the fan assembly and is configured to magnetically attract the fan assembly to a ferromagnetic surface. The flexible constraint component has a first end connected to the fan assembly and a second end configured to be fixed to the ferromagnetic surface when the fan is in use. When the fan assembly is detached from the ferromagnetic surface after the magnetic attraction of the magnetic component is overcome, the flexible constraint component is configured to limit a maximum distance between the fan assembly and the ferromagnetic surface to less than a distance at which the magnetic component generates sufficient magnetic adsorption to hold the fan assembly in abutment with the ferromagnetic surface.

### TECHNICAL FIELD

The present disclosure relates to the technical field of household appliances, and in particular to a magnetic attraction fan that is suitable for use in a vibrating environment and is capable of automatic resetting.

### BACKGROUND

Conventional magnetic attraction fans are widely used in various mobile scenarios owing to their convenient attachment and detachment without the need for tools. However, in environments with sustained vibration, such as golf carts, agricultural vehicles and construction machinery, traditional magnetic attraction fans that rely solely on magnetic fixation are prone to overcome the magnetic force under vibration, causing the fan to detach from the adsorption surface, resulting in the fan falling and being damaged, and even leading to safety accidents.

### SUMMARY

In order to overcome the deficiencies of the prior art, the present disclosure provides a fan with a simple structure, anti-drop function and automatic resetting capability, which is used to solve the problem of reliable fixation of existing fans in vibrating environments.

To realize the above objective, the present disclosure provides a fan, including: a fan assembly configured to convert electrical energy into mechanical energy for generating airflow; a magnetic component connected to the fan assembly and configured to magnetically attract the fan assembly to a ferromagnetic surface; a flexible constraint component having a first end connected to the fan assembly and a second end configured to be fixed to the ferromagnetic surface when the fan is in use; when the fan assembly is detached from the ferromagnetic surface after the magnetic attraction of the magnetic component is overcome, the flexible constraint component is configured to limit a maximum distance between the fan assembly and the ferromagnetic surface to less than a distance at which the magnetic component generates sufficient magnetic adsorption to hold the fan assembly in abutment with the ferromagnetic surface.

The beneficial effects of the present disclosure are as follows: through the arrangement of the above structure, during use, the magnetic component securely magnetically attracts the fan assembly onto a ferromagnetic surface in a vibrating environment such as on a golf cart, thereby realizing tool-free rapid attachment and detachment. One end of the flexible constraint component is connected to the fan assembly, and the other end is fixed relative to the ferromagnetic surface. Its length is configured such that, when the fan assembly momentarily overcomes the magnetic attraction force and detaches due to travel-induced vibration, the flexible constraint component limits the maximum distance between the fan assembly and the ferromagnetic surface to within the distance at which the magnetic component can re-establish effective magnetic adsorption, so that the fan assembly automatically pulled back and re-attaches in the vibration gap without manual intervention. Thus, while retaining the advantage of convenient pick-and-place of the magnetic attraction fan, the present disclosure realizes the synergistic effect of anti-drop and automatic resetting in a vibrating environment, significantly improving the reliability, safety and user experience of the fan in mobile scenarios such as golf carts.

### BRIEF DESCRIPTION OF DRAWINGS

In order to more clearly illustrate the technical solutions in the embodiments of the present disclosure, the drawings required for use in the description of the embodiments will be briefly introduced below. The drawings described below are merely some embodiments of the present disclosure. For those of ordinary skill in the art, other drawings can also be obtained according to these drawings without creative effort.

The present disclosure will be further described below in conjunction with the drawings and embodiments.

FIG. 1 is a schematic structural diagram of the fan according to a first embodiment of the present disclosure, shown in a first angle.

FIG. 2 is a schematic structural diagram of the fan according to the first embodiment of the present disclosure, shown in a second angle.

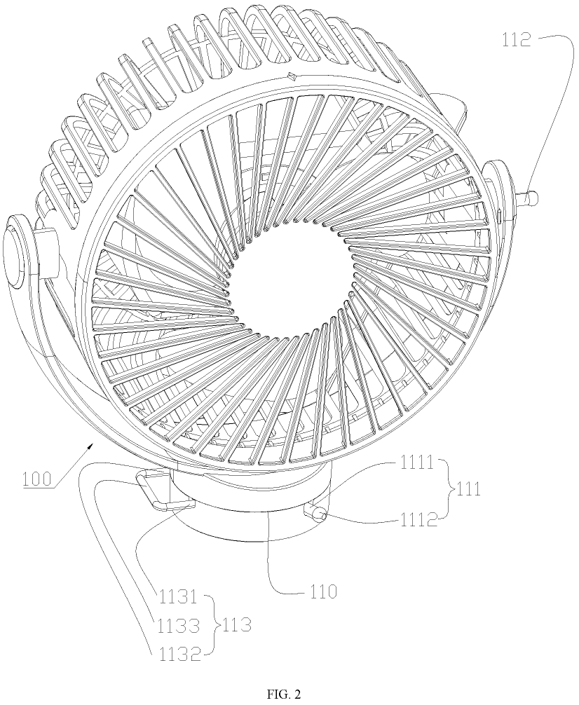

FIG. 3 is an exploded structural schematic diagram of the fan according to the first embodiment of the present disclosure.

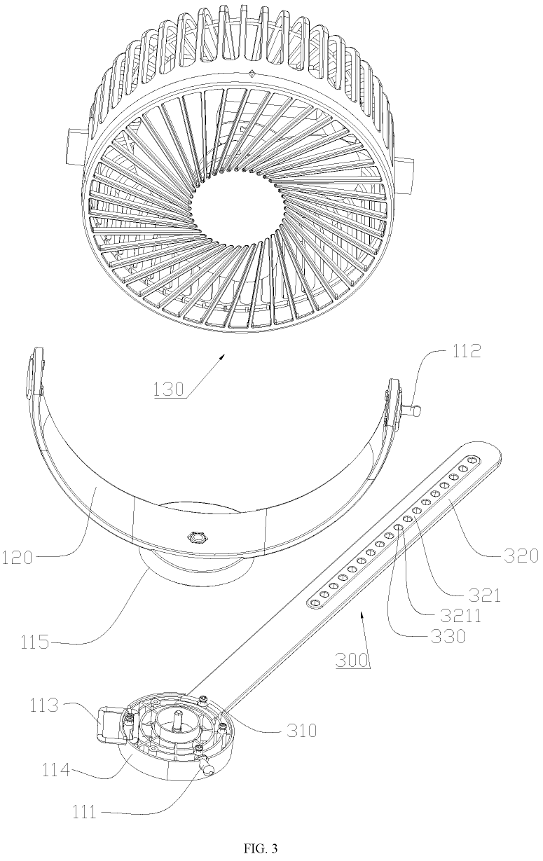

FIG. 4 is a schematic structural diagram of a flexible constraint component of the fan according to the first embodiment of the present disclosure.

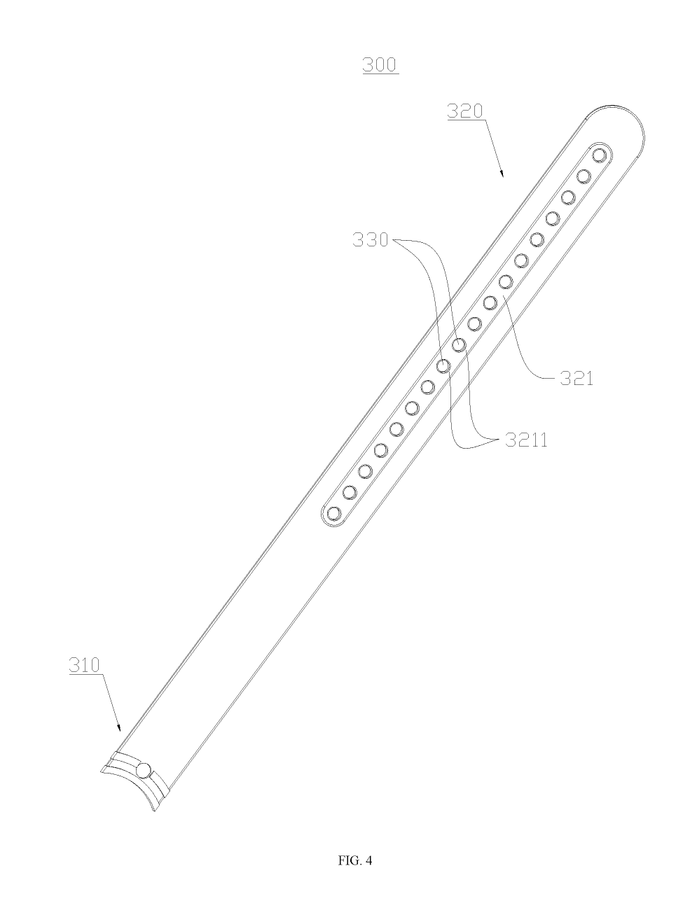

FIG. 5 is an exploded structural schematic diagram of a fan main body of the fan according to the first embodiment of the present disclosure.

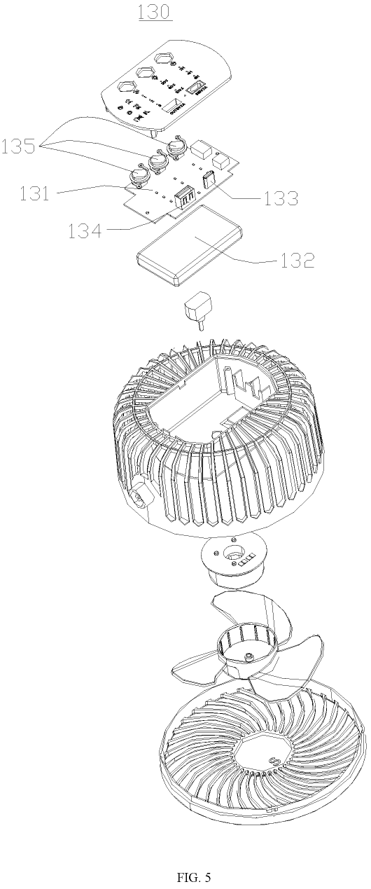

FIG. 6 is a schematic structural diagram of the fan according to the first embodiment of the present disclosure, in which the flexible constraint component is directly snap-fitted to a first snap-fit protrusion and mounted on a ferromagnetic surface of a target component.

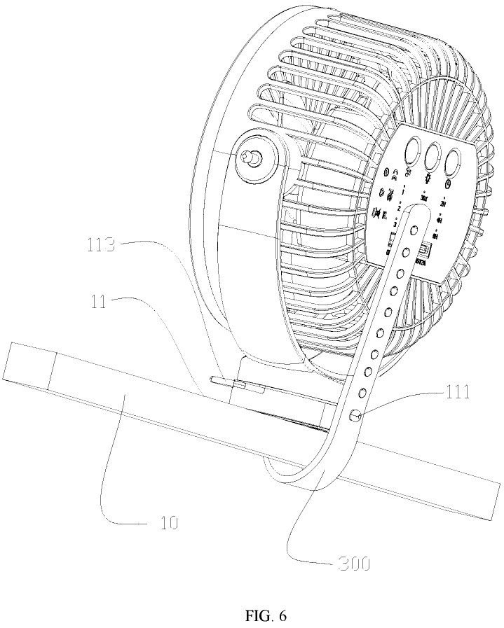

FIG. 7 is a schematic structural diagram of the fan according to the first embodiment of the present disclosure, in which the flexible constraint component passes through a gap between a middle portion of a rigid fold-back component and the base, and then folded back and is snap-fitted to the first snap-fit protrusion, thereby being mounted on the ferromagnetic surface of the target component.

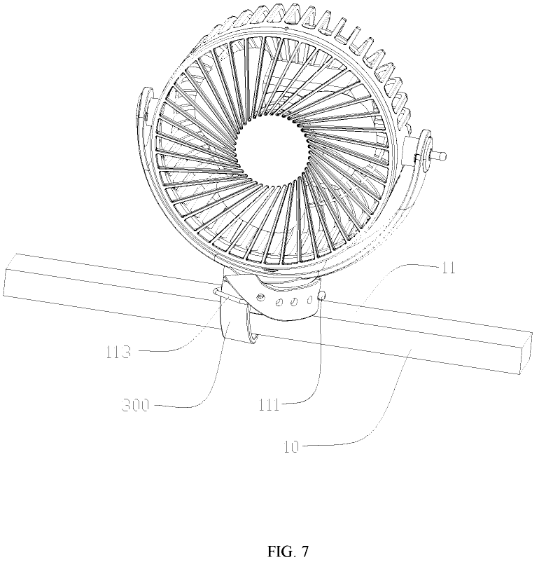

FIG. 8 is a schematic structural diagram of the fan according to a second embodiment of the present disclosure, shown in a first angle.

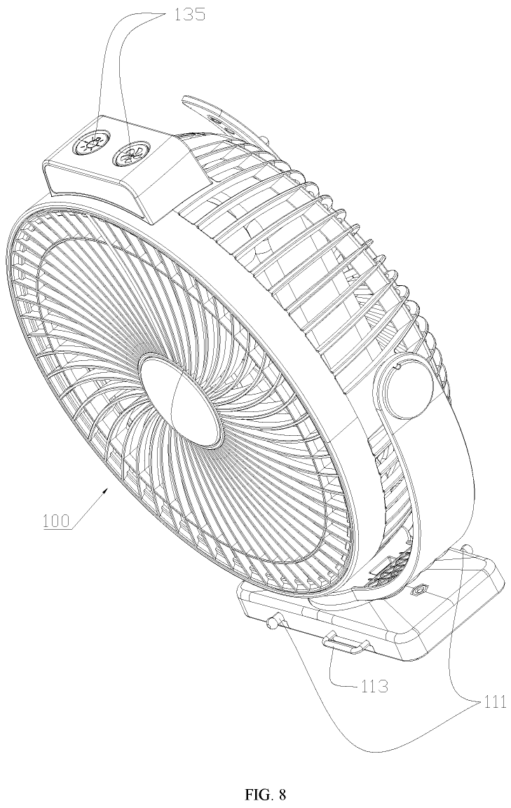

FIG. 9 is a schematic structural diagram of the fan according to the second embodiment of the present disclosure, shown in a second angle.

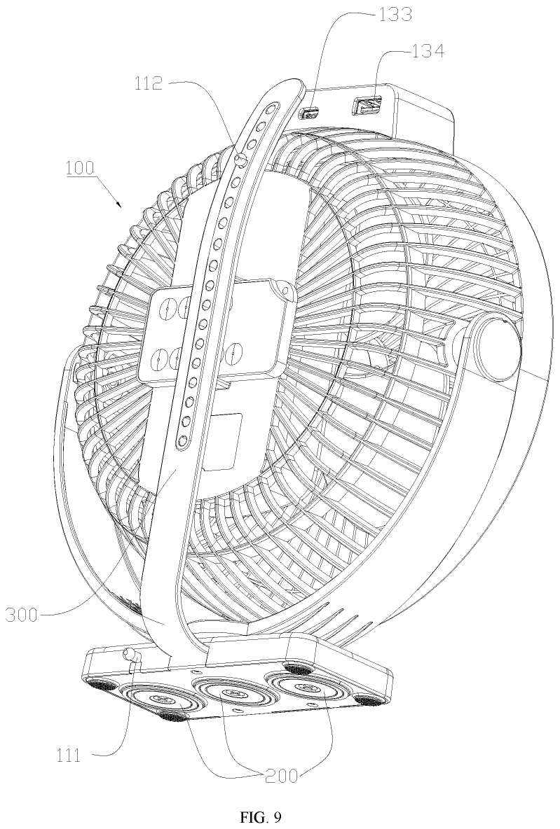

FIG. 10 is a schematic structural diagram of the fan according to the second embodiment of the present disclosure, in which the flexible constraint component directly snap-fitted to a first snap-fit protrusion and mounted on a ferromagnetic surface of a target component.

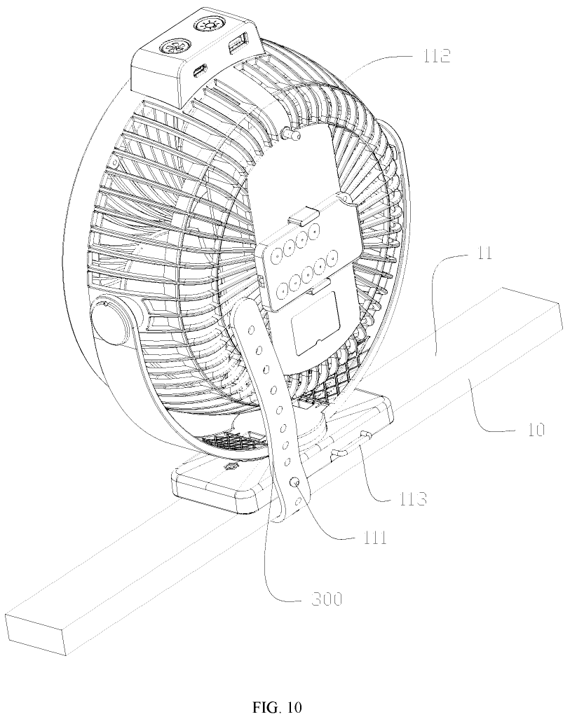

FIG. 11 is a schematic structural diagram of the fan according to the second embodiment of the present disclosure, in which the flexible constraint component passes through a gap between a middle portion of a rigid fold-back component and the base, and then folded back and snap-fitted to the first snap-fit protrusion, and is mounted on the ferromagnetic surface of the target component.

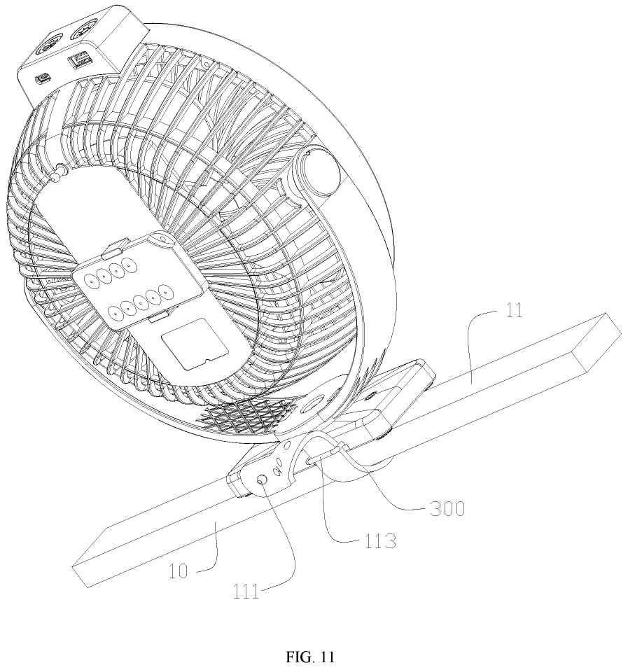

### Description of the Reference Numerals

10. target component; 11. ferromagnetic surface; 100. fan assembly; 200. magnetic component; 300. flexible constraint component; 110. base; 111. first snap-fit protrusion; 1111. columnar body; 1112. spherical head; 112. second snap-fit protrusion; 113. fold-back component; 1131. first fixed end; 1132. second fixed end; 1133. middle portion; 114. base seat; 115. rotating seat; 120. fan bracket; 130. fan main body; 131. control circuit board; 132. rechargeable power source; 133. charging port; 134. discharging port; 135. control button; 310. first end; 320. second end; 321. buckle; 3211. buckle position; 330. snap-fit through hole.

### DETAILED DESCRIPTION OF THE EMBODIMENTS

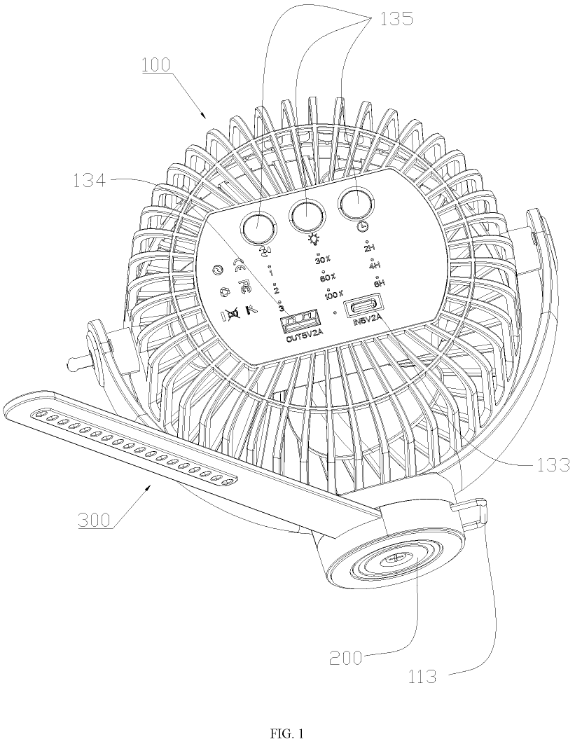

Referring to FIGS. 1 - 11, a fan, including: a fan assembly 100, a magnetic component 200, and a flexible constraint component 300. The fan assembly 100 is configured to convert electrical energy into mechanical energy for generating airflow.

The magnetic component 200 is connected to the fan assembly 100, and the magnetic component 200 is configured to separably magnetically attract the fan assembly 100 to a ferromagnetic surface 11. The flexible constraint component 300 has a first end 310 and a second end 320, the first end 310 is connected to the fan assembly 100, and the second end 320 is configured to be fixed relative to the ferromagnetic surface 11 when the fan is in use. The length of the flexible constraint component 300 is configured such that: when the fan assembly 100 overcomes the magnetic attraction of the magnetic component 200 due to vibration and separates from the ferromagnetic surface 11, the flexible constraint component 300 restricts a maximum distance between the fan assembly 100 and the ferromagnetic surface 11 to be less than the distance at which the magnetic component 200 generates effective magnetic adsorption sufficient to hold the fan assembly 100 in abutment with the ferromagnetic surface 11.

Through the arrangement of the above structure, in use, the magnetic component 200 is preferably configured with a strong magnet. Tests show that a strong magnet capable of providing a planar pull force greater than 10kg achieves excellent effects and can separably and firmly magnetically attract the fan assembly 100 to ferromagnetic surfaces 11 of equipment under various working conditions, such as metal mounting surfaces of golf carts, construction machinery, off-road vehicles, agricultural equipment, vehicle-mounted equipment and the like. The magnetic component 200 with the strong magnetic configuration can directly form a close fit with the ferromagnetic surface 11 without any interlayer, achieving zero-gap contact, thereby avoiding the additional magnetic reluctance introduced by the plastic or rubber covering layer of a conventional coated magnet, ensuring that magnetic lines of force penetrate the working interface with minimal loss, and providing a stable and continuous adsorption fixing force for the fan assembly 100 under conventional vibration working conditions. Even in the face of high-frequency small-amplitude vibrations caused by vehicle starting and stopping or equipment operation, the stable adsorption of the fan assembly 100 can still be maintained, greatly reducing the probability of the fan assembly 100 detaching from the ferromagnetic surface 11. At the same time, the separable adsorption characteristic also makes the installation, disassembly and position adjustment of the fan more flexible and convenient.

Under oscillation working conditions, such as instantaneous strong impacts and large-amplitude vibrations generated when an off-road vehicle traverses an unpaved road or when construction machinery performs high-intensity operations, there may be a risk of instantaneous detachment when the impact force causes the fan assembly 100 to overcome the magnetic attraction of the magnetic component 200 and separates from the ferromagnetic surface 11. The present disclosure solves this industry pain point through the special configuration of the flexible constraint component 300. The flexible constraint component 300 is made of a flexible material with high tensile strength and low elongation. Its first end 310 forms a reliable anti-disengagement connection with the fan assembly 100, and its second end 320 is fixedly connected to the equipment body where the ferromagnetic surface 11 is located in the use state, thereby forming a fixed end that is stationary relative to the ferromagnetic surface 11. Moreover, the length of the flexible constraint component 300 is calibrated and configured, and its maximum extendable length in the use state is strictly limited to less than the critical distance at which the magnetic component 200 is capable of re-generating effective adsorption sufficient to hold the fan assembly 100 abutted against the ferromagnetic surface 11.

Repeated tests have shown that, when paired to the magnetic component 200 with the strong magnetic configuration, limiting the maximum extendable length of the flexible constraint component 300 within 5mm achieves a 100% automatic reset success rate. When the fan assembly 100 undergoes instantaneous detachment due to an instantaneous strong vibration impact, the flexible constraint component 300 is instantly pulled straight, thereby rigidly restricting the flying-off displacement of the fan assembly 100 and fundamentally preventing the fan assembly 100 from falling from the equipment and causing component damage or even safety accidents that injure nearby personnel. At the same time, since the maximum distance between the fan assembly 100 and the ferromagnetic surface 11 restricted by the flexible constraint component 300 is always less than the effective adsorption critical distance of the magnetic component 200, the magnetic component 200 remains within the action range capable of generating an effective magnetic attraction force on the ferromagnetic surface 11 even when instantaneous detachment occurs due to the instantaneous strong vibration impact. After the instantaneous impact force subsides, the magnetic attraction force of the magnetic component 200 will immediately pull the fan assembly 100 back to re-attach to the ferromagnetic surface 11, completing automatic reset without manual intervention and quickly restoring a stable adsorption fixing state.

In the conventional working condition in which the fan assembly 100 is normally magnetically attracted and fixed, the flexible constraint component 300 is in a naturally slack state and does not produce any rigid interference with the air supply angle adjustment or installation position adjustment of the fan, thereby taking into account both the flexibility of installation and use of the magnetic adsorption fan and the safety of use under extreme working conditions. The fan assembly 100 can continuously convert electrical energy into mechanical energy for generating airflow in various oscillation environments, outputting stable and strong airflow to provide a cool and comfortable air supply experience for operators in the operating environment, thereby completely solving the potential safety hazards that conventional magnetic adsorption fans are prone to detachment and falling and cannot be automatically reset under strong vibration and strong impact operating environments. It should be noted that the number of the magnetic components 200 may be more than one.

In this embodiment, the second end 320 is provided with a buckle 321, the buckle 321 is configured to detachably connect the flexible constraint component 300 to a target component 10 that includes the ferromagnetic surface 11. With the foregoing structure, the buckle 321 provides the flexible constraint component 300 with a tool-free and damage-free quick-installation and quick-disassembly fixing anchor point, forming a dual safety guarantee system together with the magnetic component 200. In use, there is no need to perform hole-drilling, welding or other modifications on the target component 10. The second end 320 of the flexible constraint component 300 can be quickly and detachably fixed to the target component 10 so that it remains stationary relative to the ferromagnetic surface 11, thereby satisfying the design requirements for fall prevention and position limitation. Disassembly is convenient, and the arrangement is adapted to various installation scenarios with ferromagnetic surfaces 11.

In this embodiment, the buckle 321 is provided with a plurality of buckle positions 3211, different buckle positions 3211 are selected to adjust the tightness with which the flexible constraint component 300 surrounds the target component 10 so as to adapt to the target components 10 of different sizes. Through the arrangement of the above structure, in use, the plurality of buckle positions can flexibly adjust the locking tightness of the flexible constraint component 300 surrounding the target component 10, adapting to target components 10 of different size specifications and greatly improving the product installation universality and scene adaptability. After adjustment, the second end of the flexible constraint component 300 and the target component 10 can form a rigid fixation without looseness, always providing a stable position-limiting anchor point to ensure reliable activation of the fall-prevention position-limiting and detachment automatic reset functions. The tightness adjustment and locking can be completed without additional tools, and the operation is convenient.

In this embodiment, the target component 10 is an elongated object having a ferromagnetic surface 11. The elongated object includes a rod-shaped object, a columnar object or a tubular object. Through the above structural definition, the core adapted installation substrate of the fan of the present solution is clarified, covering various common elongated ferromagnetic installation scenarios such as vehicle-mounted brackets, construction machinery operating rods, vehicle anti-roll frames, workstation upright rods and the like, and satisfying the surrounding locking fixation requirement of the buckle 321 and the adsorption fixation requirement of the magnetic component 200. For rod-shaped, columnar and tubular ferromagnetic surfaces, the tightness adjustment of the buckle 321 enables adaptation to elongated objects of different size specifications without the need for additional customized adaptation structures, greatly broadening the applicable scenarios of the product while ensuring stable activation of the fall-prevention position-limiting and detachment automatic reset functions.

In this embodiment, the fan assembly 100 includes a base 110, the magnetic component 200 is fixed to the base 110, and the first end 310 of the flexible constraint component 300 is connected to the base 110. Through the arrangement of the above structure, an integrated design of magnetic adsorption fixation, fall-prevention constraint and the fan main body is realized, ensuring coordinated activation of the core functions. The magnetic component 200 is fixed to the base 110, which can guarantee the fitting precision of the adsorption working surface. When matched with the strong magnetic configuration, magnetic reluctance loss can be minimized to the greatest extent and a stable adsorption fixing force can be output. The flexible constraint component 300 and the magnetic component 200 are connected to the base 110 in the same body, which can ensure that the displacements of the two are completely synchronized. When the fan assembly 100 undergoes instantaneous detachment due to vibration, the flexible constraint component 300 can precisely restrict the maximum distance between the magnetic component 200 and the ferromagnetic surface 11, matching the preset effective adsorption distance and ensuring reliable activation of the automatic reset function after detachment. At the same time, the overall machine assembly process is simplified, and the structural strength and installation convenience are improved.

In this embodiment, the flexible constraint component 300 is a binding strap. A plurality of snap-fit through holes 330 are provided on the binding strap along the length direction. The base 110 is provided with a first snap-fit protrusion 111, the first snap-fit protrusion 111 includes a columnar body 1111 and a spherical head 1112 located at the end of the columnar body 1111, and the diameter of the spherical head 1112 is larger than the diameter of the columnar body 1111. The diameter of the snap-fit through holes 330 matches the diameter of the columnar body 1111 and is smaller than the diameter of the spherical head 1112, such that the snap-fit through holes 330 are capable of elastically passing over the spherical head 1112 and engaging on the columnar body 1111.

With the foregoing structure, a tool-free, quick-assembly and quick-disassembly, multi-position adjustable anti-disengagement rigid connection is realized between the flexible constraint component 300 and the base 110 of the fan assembly 100. This connection matches the core anti-drop design of the fan according to the present disclosure and solves the industry pain point that conventional magnetically attracted fans are prone to loosening and failure under vibration operating conditions. The flexible constraint component 300 is preferably prepared from a high tensile strength, low elongation, moderately elastic and wear-resistant binding strap, such as a high-strength nylon 66 woven strap or a thermoplastic polyurethane (TPU) coated polyester woven strap.

The flexible constraint component 300 is capable of withstanding an axial static tensile force that far exceeds the self-weight of the fan assembly 100 and the instantaneous tensile force peak value under extreme impact operating conditions, thereby ensuring the structural reliability of the anti-drop constraint at the base material level. A plurality of snap-fit through holes 330 are arranged at equal intervals along the length direction of the binding strap, thereby forming a multi-position adjustment structure. On the one hand, the effective working length of the binding strap can be calibrated to match the core design requirements of the present solution, i.e., when the fan assembly 100 is detached, the maximum spacing restricted by the flexible constraint component 300 is always smaller than the critical distance at which the magnetic component 200 can re-establish effective attraction. On the other hand, the snap-fit through holes 330 cooperate with the multiple snap-fit positions 3211 of the buckle 321 to form a dual adjustment system, which perfectly adapts to rod-shaped, column-shaped or tubular target components 10 of different diameters and different specifications, thereby broadening the installation scenario adaptability of the product.

The first snap-fit protrusion 111 integrally formed on the base 110 adopts an anti-disengagement self-locking structure consisting of a columnar body and a spherical head. During installation, the snap-fit through holes 330 of the binding strap can undergo a slight elastic deformation by virtue of its own elastic property, smoothly passing over the spherical head 1112 having a larger diameter and snapping onto the columnar body 1111 that matches the diameter of the through hole. After snapping is completed, because the diameter of the snap-fit through holes 330 is smaller than the diameter of the spherical head 1112, the spherical head 1112 forms a full-circumferential axial stop limit. Even under harsh operating conditions such as continuous bumping and strong vibration impact of off-road vehicles and construction machinery, the binding strap will not detach itself from the first snap-fit protrusion 111, thereby preventing the anti-drop function from failing due to disconnection of the first end of the flexible constraint component 300 and providing a stable connection guarantee throughout the entire process for the limiting constraint and automatic re-attachment functions. At the same time, the spherical head 1112 adopts a full-arc transition design without any sharp edges or corners, which not only ensures smoothness during snapping but also prevents scratching or stress concentration fracture of the binding strap during vibration pulling, thereby prolonging the service life of the product.

In the snapped state, the binding strap can rotate circumferentially around the columnar body 1111, which can effectively prevent the binding strap from twisting or winding and ensure that its effective working length is always maintained within the preset calibrated range without interfering with the flexible adjustment of the fan air supply angle. In cooperation with the strong magnetic configuration of the magnetic component 200 preferred in the present solution, synergistic operation of magnetic attraction fixation and anti-drop constraint is realized. It should be noted that the number of the first snap-fit protrusions 111 may be more than one.

In the present embodiment, a second snap-fit protrusion 112 is further included. The second snap-fit protrusion 112 is disposed on the fan assembly 100 at a position different from the first snap-fit protrusion 111. The second snap-fit protrusion 112 has the same structure as the first snap-fit protrusion 111 and is used for snapping with the snap-fit through holes 330 when the flexible constraint component 300 is not in use, so as to prevent the flexible constraint component 300 from hanging down.

Through the arrangement of the above structure, when the flexible constraint component 300 does not need to be deployed for use, the snap-fit through holes 330 thereon can be quickly snapped and fixed with the second snap-fit protrusion 112 of the same structure, so that the binding strap is neatly stored on the surface of the fan assembly 100, thereby avoiding problems such as hanging down, swinging, winding around fan blades or interfering with air supply during traveling or operation. The spherical anti-disengagement structure also ensures reliable connection in the stored state and will not loosen due to vibration. Thereby maintaining a neat overall appearance of the entire device and further improving the operational stability and safety of the fan under normal use conditions. It should be noted that the number of the second snap-fit protrusions 112 may be more than one.

In the present embodiment, the flexible constraint component 300 is an elastic component. Through the arrangement of the above structure, when the flexible constraint component 300 is configured as an elastic component, it can buffer the impact through its own elastic deformation when the fan assembly 100 is instantaneously detached due to vibration, thereby avoiding structural damage caused by rigid pulling. At the same time, after the instantaneous impact disappears, the elastic restoring force assists the fan assembly 100 to return to and fit the ferromagnetic surface 11 more quickly, cooperating with the attraction force of the magnetic component 200 and further improving the reliability and response speed of automatic re-attachment.

In the present embodiment, a fold-back component 113 is further provided on the base 110, and the flexible constraint component 300 passes through the fold-back component 113 and then snaps with the first snap-fit protrusion 111. The fold-back component 113 is made of a rigid material and includes a first fixed end 1131, a second fixed end 1132 and a middle portion 1133 connected between the first fixed end 1131 and the second fixed end 1132. The first fixed end 1131 and the second fixed end 1132 are fixedly connected to the base 110, and a gap for the flexible constraint component 300 to pass through is formed between the middle portion 1133 and the base 110.

With the foregoing structure, when in use, the flexible constraint component 300 passes through the gap between the middle portion 1133 of the rigid fold-back component 113 and the base 110 and then snaps with the first snap-fit protrusion 111, thereby forming a more stable folding-back positioning structure. Since the fold-back component 113 is made of a rigid material with both ends fixed to the base 110, the middle portion 1133 will not deform or shake under vibration or pulling and can reliably define the direction and constraint fulcrum of the flexible constraint component 300, preventing it from shifting or moving during use and ensuring a constant constraint length. At the same time, the rigid support can effectively disperse the impact tensile force, preventing the flexible constraint component 300 from jamming or excessive wear during the detachment and re-attachment process, and further improving the stability of the anti-drop limiting and automatic re-attachment functions. It should be noted that the flexible constraint component 300 may also directly snap with the first snap-fit protrusion 111 without passing through the gap between the middle portion 1133 of the rigid fold-back component 113 and the base 110.

In the present embodiment, the base 110 includes a base seat 114 and a rotating seat 115. The first snap-fit protrusion 111 and the flexible constraint component 300 are disposed on the base seat 114, and the rotating seat 115 is rotatably connected to the base seat 114.

Through the arrangement of the above structure, when in use, the rotating seat 115 can rotate relative to the base seat 114, thereby realizing flexible adjustment of the fan’s airflow supply angle and meeting the directional air supply requirements in different scenarios. At the same time, the first snap-fit protrusion 111 and the flexible constraint component 300 are arranged on the fixed base seat 114. So that when the fan rotates to adjust the angle, the flexible constraint component 300 will not twist or wind along with it, and the constraint length and force direction remain stable at all times. This ensures the flexibility of use while preventing the constraint from becoming ineffective or the length from changing due to rotation, thereby ensuring that the anti-drop limiting and automatic re-attachment functions are not affected by angle adjustment and remain stable and reliable.

In the present embodiment, the fan assembly 100 further includes a fan bracket 120 and a fan main body 130. The fan main body 130 is rotatably connected to the fan bracket 120. The fan bracket 120 is fixedly connected to the rotating seat 115, so that the fan main body 130 can rotate relative to the base seat 114 to adjust the air supply angle.

Through the arrangement of the above structure, when in use, the fan main body 130 can realize pitch angle adjustment on the fan bracket 120 and can also perform circumferential rotation relative to the base seat 114 along with the rotating seat 115, thereby achieving multi-angle and large-range air supply direction adjustment and meeting the blowing requirements of different use scenarios. Moreover, since both the flexible constraint component 300 and the first snap-fit protrusion 111 are disposed on the base seat 114 that does not rotate with the rotating seat 115, the flexible constraint component 300 will not undergo twisting, winding or length change when the air supply angle is adjusted. This not only guarantees the flexibility of adjustment but also does not affect the stable realization of the anti-drop limiting and automatic re-attachment functions.

Through the cooperative design of the fan bracket 120 and the rotating seat 115, the fan of the present embodiment realizes flexible air outlet direction adjustment while ensuring posture maintaining capability under harsh vibration environments, continuously providing users with precise and comfortable directional airflow and further enhancing the user experience. It should be noted that, in the present embodiment, the fan bracket 120 and the rotating seat 115 are fixedly connected by means of integral forming, but this fixing manner is merely an exemplary illustration and is not the only optional implementation. Conventional mechanical fixing manners such as screw connection, bolt connection, snap-fit connection, riveting, adhesive bonding or pin connection may also be adopted.

In the present embodiment, the fan main body 130 includes a control circuit board 131, a rechargeable power source 132, a charging port 133 and a discharging port 134. The charging port 133 is a universal serial bus type-C (USB-C) interface. Through the arrangement of the above structure, when in use, the fan main body 130 integrates power management and charge-discharge functions. The control circuit board 131 is responsible for coordinating the charge-discharge logic of the rechargeable power source 132, voltage conversion and fan motor drive. The rechargeable power source 132 (such as a lithium-ion battery pack) enables the fan to operate normally when disconnected from external power supply, which is suitable for mobile or vibration environments. The charging port 133 adopts a USB-C interface for charging the rechargeable power source 132, and the discharging port 134 (such as USB-A or another USB-C) can be used for emergency power supply to other external devices (such as mobile phones and lighting lamps).

Specifically, the USB-C interface of the charging port 133 supports forward and reverse plugging and unplugging, wide voltage input (5V/9V/12V) and fast charging protocols (such as USB quick charge (PD) and qualcomm quick charge (QC)). In cooperation with the charging management chip on the control circuit board 131, fast and safe charging can be realized. The discharging port 134 can simultaneously output electric energy to the outside while the fan is operating, thereby forming a mobile power supply function. In a vibration environment, the latch-type design of the USB-C interface ensures the connection reliability of the charging cable. When used in conjunction with the strong magnetic configuration of the magnetic component 200, the effect is even more significant: the fan main body 130 is stably attached to the ferromagnetic surface 11 due to strong magnetic attraction, so that the connection of its charging and discharging ports will not suffer from poor contact due to fan shaking. At the same time, the runtime provided by the rechargeable power supply 132 (continuous operation for 8-12 hours on a single full charge) enables the fan to continuously output airflow in outdoor or vehicle-mounted environments without external power. Through the above integrated design, the fan of the present embodiment is not only an air supply device but also a portable power hub, significantly enhancing the multifunctional practicality under vibration environments.

In this embodiment, the fan main body 130 further includes at least one control button 135. Through the arrangement of the above structure, convenient operations for functions such as fan start/stop and wind-speed gear switching can be realized during use. In cooperation with the control circuit board 131, a concise and intuitive human-machine interaction is formed. Operators can perform quick one-handed adjustments in operating scenarios such as vehicle-mounted or construction machinery environments, making use more convenient and efficient. In fact, this embodiment is further provided with a light strip, a motor, and fan blades, wherein the light strip is arranged between the motor and the fan blades. The control buttons comprise an air-supply gear control button, an air-supply time control button, and a lighting control button. Among them, the air-supply gear control button (including three gears: 1, 2, and 3) enables the user to control the rotational speed of the motor—and thereby the rotational speed of the fan blades—according to their demand for wind force intensity, ultimately achieving the purpose of flexibly adjusting the fan’s air-supply intensity and satisfying usage requirements under different scenarios. The air-supply time control button (including timed air supply of 2 hours, 4 hours, and 6 hours) can realize a timing function, allowing the user to preset the operating duration of the fan, after which the fan automatically stops working—both energy-saving and environmentally friendly, while also avoiding the inconvenience of manual shutdown. The lighting control button (including 30% brightness, 60% brightness, and 100% brightness) can adjust the light brightness, enabling the user to select an appropriate brightness according to ambient lighting conditions or personal preference, thereby enhancing the comfort of use. This targeted button arrangement makes every operation clear and distinct, allowing users to get started quickly, effectively preventing operational confusion, and greatly enhancing the flexibility, convenience, and user-friendly experience of the product.

In this embodiment, the snap-fit through-holes 330 are circular holes, and the spherical head 1112 is hemispherical or spherical. Through the arrangement of the above structure, during use, one of the circular snap-fit through-holes 330 cooperates with the hemispherical or spherical head 1112; the curved-surface transition is smooth, which, during assembly, facilitates the elastic deformation of the flexible constraint component 300 and allows it to snap in smoothly, making jamming or tearing unlikely to occur. Moreover, the spherical end face enables uniform force distribution, which, under vibration and pulling working conditions, can reduce stress concentration. Thereby ensuring a firm connection that does not loosen while also effectively extending the service life of the flexible constraint component 300.

In this embodiment, the first end 310 of the flexible constraint component 300 is fixedly connected to the fan assembly 100 by means of snap-fit, hinge, riveting, bonding, or integral molding. The above multiple connection methods can be flexibly selected according to product structure, process cost, and usage conditions. All of them can achieve reliable fixation between the first end 310 and the fan assembly 100, thereby preventing the anti-drop limiting and automatic reset functions from failing. This embodiment specifically adopts the snap-fit method: a snap-fit hole is provided at the first end 310 of the flexible constraint component 300, and a corresponding snap-fit shaft is provided on the base. Snap-fit fixation between the flexible constraint component 300 and the base 110 is realized through shaft-hole cooperation, which facilitates quick replacement when the flexible constraint component 300 is accidentally damaged.

The above descriptions are one or more embodiments provided in conjunction with specific content and are not intended to limit the specific implementation of the present disclosure solely to these descriptions. Any approximations or similarities to the methods, structures, etc., of the present disclosure, or any technical deductions or substitutions made on the premise of the inventive concept of the present disclosure, shall be deemed to fall within the protection scope of the present disclosure.

What is claimed is:

1. A fan, comprising:
a fan assembly configured to convert electrical energy into mechanical energy for generating airflow;
a magnetic component connected to the fan assembly and configured to magnetically attract the fan assembly to a ferromagnetic surface;
a flexible constraint component having a first end connected to the fan assembly and a second end configured to be fixed to the ferromagnetic surface when the fan is in use;
wherein, when the fan assembly is detached from the ferromagnetic surface after the magnetic attraction of the magnetic component is overcome, the flexible constraint component is configured to limit a maximum distance between the fan assembly and the ferromagnetic surface to less than a distance at which the magnetic component generates sufficient magnetic adsorption to hold the fan assembly in abutment with the ferromagnetic surface.

2. The fan of claim 1, wherein the second end of the flexible constraint component is provided with a buckle configured to enable the flexible constraint component to be detachably fastened around a target component that includes the ferromagnetic surface, so as to detachably secure the fan assembly on the ferromagnetic surface.

3. The fan of claim 2, wherein the buckle is provided with a plurality of buckle positions, such that a tightness of the flexible constraint component when encircling the target component is adjusted by selecting different ones of the plurality of buckle positions to accommodate target components of different sizes.

4. The fan of claim 3, wherein the target component is an elongated object having the ferromagnetic surface.

5. The fan of claim 4, wherein the target component is a rod-shaped object, a columnar object, or a tubular object.

6. The fan of claim 1, wherein the fan assembly comprises a base, the magnetic component is fixed to the base, and the first end of the flexible constraint component is connected to the base.

7. The fan of claim 6, wherein the flexible constraint component is a binding strap provided with a plurality of snap-fit through holes along its length direction;
the base is provided with a first snap-fit protrusion having a columnar body and a spherical head located at an end of the columnar body, wherein a diameter of the spherical head is larger than a diameter of the columnar body; and
a diameter of each of the plurality of snap-fit through holes matches the diameter of the columnar body and is smaller than the diameter of the spherical head, and each of the plurality of snap-fit through holes is configured for elastically passing over the spherical head and snapping onto the columnar body.

8. The fan of claim 7, wherein the base is further provided with a second snap-fit protrusion disposed on the fan assembly at a position different from the first snap-fit protrusion, the second snap-fit protrusion has the same structure as the first snap-fit protrusion and is configured to snap-engage with one of the plurality of snap-fit through holes when the flexible constraint component is not in use, so as to prevent the flexible constraint component from dangling.

9. The fan of claim 7, wherein the flexible constraint component is an elastic component.

10. The fan of claim 7, wherein the base is further provided with a fold-back component, and the flexible constraint component passes through the fold-back component and then snap-engages with the first snap-fit protrusion.

11. The fan of claim 10, wherein the fold-back component comprises a first fixed end, a second fixed end, and a middle portion connecting the first fixed end and the second fixed end, the first fixed end and the second fixed end being fixedly connected to the base, and a gap for the flexible constraint component to pass through is formed between the middle portion and the base.

12. The fan of claim 11, wherein the fold-back component is made of a rigid material.

13. The fan of claim 7, wherein the base comprises a base seat and a rotating seat, the first snap-fit protrusion and the flexible constraint component are disposed on the base seat, and the rotating seat is rotatably connected to the base seat.

14. The fan of claim 13, wherein the fan assembly further comprises a fan bracket and a fan body, the fan body being rotatably connected to the fan bracket; and
the fan bracket is fixedly connected to the rotating seat; the rotating seat being configured to enable the fan body to rotate relative to the base seat to adjust an air supply angle.

15. The fan of claim 14, wherein the fan body comprises a control circuit board, a rechargeable power source, and a charging port.

16. The fan of claim 15, wherein the fan body further comprises a discharging port.

17. The fan of claim 16, wherein the charging port is a universal serial bus type-C (USB-C) interface.

18. The fan of claim 15, wherein the fan body further comprises at least one control button.

19. The fan of claim 7, wherein each of the plurality of snap-fit through holes is circular, and the spherical head is hemispherical or spherical.

20. The fan of claim 1, wherein the first end of the flexible constraint component is connected to the fan assembly by means of snap-fitting, hinging, riveting, adhesive bonding, or integral molding.
